(19) United States
(12) Patent Application Publication
(10) Pub. No.: US 2007/0204711 A1
(43) Pub. Date: Sep. 6, 2007

(54) Ball screw mechanism for an electromechanical steering system and nut for a ball screw mechanism

(76) Inventors: Martin Budaker, Heubach (DE); Klaus-Dieter Leimbach, Eschach (DE); Walter Bulling, Wissgoldingen (DE); Oliver Hetzel, Waldstetten (DE)

Correspondence Address: JORDAN AND HAMBURG LLP, 122 EAST 42ND STREET, SUITE 4000, NEW YORK, NY, 10168, US

(21) Appl. No.: 11/654,937

(22) Filed: Jan. 18, 2007

Related U.S. Application Data
(63) Continuation of application No. PCT/EP05/53424, filed on Jul. 18, 2005.

(30) Foreign Application Priority Data
Aug. 3, 2004 (DE) 10 2004 037 599.2

(51) Int. Cl. F16H 35/00; F16H 1/24

(52) U.S. Cl. 74/388 PS; 74/424.87

(57) ABSTRACT

A ball bearing helical gearing for an electromechanical steering system of a vehicle includes a threaded spindle and a nut. The threaded spindle and nut are provided with ball bearing raceways for jointly accommodating load-transferring ball bearings inside the nut, and the nut has ball bearing routing parts for guiding out and introducing the ball bearings into the ball bearing raceways. In order to create a ball bearing helical gearing whose ball bearing guidance enables a uniform, low-noise operation of the ball bearing helical gearing, particularly when the threaded spindle is acted upon by lateral forces, it is provided that the nut comprising the ball bearing routing parts is, in its transition area into the ball bearing raceways, designed in such a manner that a fork structure of a gothic raceway profile of the ball bearing raceways is formed in this area at the height of a contact or pressure angle, and a contact surface of the ball bearing raceways of the threaded spindle with regard to the ball bearings that changes in an almost continuously progressive manner is ensured for a defined jolt-free entering and exiting of the ball bearings into and out of a load entry and load exit zone. The ball bearings are arranged in a closed chain over approximately two or more threads in the ball bearing raceways.

### BACKGROUND OF THE INVENTION

1. Field of the Invention

The present invention relates to a ball screw mechanism for an electromechanical steering system of a vehicle, in particular for a motor vehicle and to a nut for a ball screw mechanism of a steering system.

2. Description of the Prior Art

Ball screw mechanisms for steering systems or recirculating ball steering mechanisms for vehicles are known. EP 0 133 003 B1 describes a ball screw mechanism for an electromechanical steering system of a motor vehicle, with a threaded spindle which is operatively connected to a manual steering control by way of a pinion and a rack and which has helical ball bearing raceways around its circumference, the threaded spindle passing through a nut, which is supported so that it is axially immovable in a transmission casing and in relation to which the threaded spindle is axially moveable as the nut rotates. The nut has helical ball bearing raceways. The ball bearing raceways of the threaded spindle and of the nut together serve to accommodate load-transmitting ball bearings inside the axial area of the nut. The threaded spindle is operatively connected by a connecting mechanism, comprising track rods and steering arms, to the steered wheels of the vehicle, an axial movement of the threaded spindle producing an adjustment of the wheel angle of the steered wheels of the vehicle.

The running characteristics of such ball screw mechanisms vary according to the geometric design of the ball bearing raceways of the threaded spindle and the nut in the load-bearing threaded area and in particular according to the geometric ratios of the ball bearing raceway, the ball bearing guidance over the load entry and load exit zone into the nut, and the thread turns of the latter. In the case of the load entry zone and load exit zone the geometric design must be optimized in such a way that each ball bearing runs precisely out of the ball bearing guide and smoothly into the load-bearing area of the thread turn, in which the ball bearing is exposed to the external loads exerted by the pre-stressing force and the load force. Smooth running of the ball screw mechanism with constant torque and also the amount of heat and noise generated by the ball screw mechanism are determined by the geometric ratios.

The known steering mechanisms are based on the principle of a single chain reversal of the ball bearing chains in the steering nut, the ball bearing raceway being continuous in the area of the ball guide and the ball screw mechanism tending to generate noise when the threaded spindle is acted upon by lateral forces, that is to say the high forces perpendicular to the longitudinal axis of the rack and the threaded spindle that are particularly prone to occur in such electromechanical steering systems, since the threaded spindle and its affixed connecting mechanism linking it to the steered wheels of the vehicle is radially not uniformly supported by the ball bearings in the area of the ball bearing guide. Moreover, the ball bearings, especially when the threaded spindle is acted upon by lateral forces in a transitional area from the ball bearing guide to the ball bearing raceways, are forced into a load-bearing thread area, the usual ball bearing guide that terminates in a circular opening with an inlet edge contributing to a jerky entry of the ball bearings into the load entry zone of the ball bearing raceways or a similar exit from the load exit zone thereof.

### SUMMARY OF THE INVENTION

The object of the present invention is to create a ball screw mechanism for an electromechanical steering system, the load entry and load exit zone of which will allow a uniform, quiet running of the ball screw mechanism.

Arranging the ball bearings in a closed chain in the ball bearing raceways of the ball screw mechanism affords the ball bearings a smooth entry to and exit from the ball bearing raceways of the threaded spindle and the nut. The closed ball bearing chain in the ball bearing raceways results means that there is no interruption of the load-bearing ball bearing raceway and hence also no scope for the generation of impact noises due to the influence of lateral forces acting on the threaded spindle.

In an especially preferred exemplary embodiment of the ball screw mechanism the load entry and load exit zone of the nut in its transitional area to the thread grooves is designed so as to result in an almost continuously progressive change in the contact area between the ball bearing raceways of the threaded spindle and the ball bearings. In this transitional area the ball bearings are not abruptly accelerated or decelerated by the gradually increasing or diminishing contact area with the ball bearing raceways of the threaded spindle or by the likewise gradually varying friction which acts on them as a result. The ball bearings run out of the ball bearing guide in the nut along two edges of a gothic raceway profile until they enter the thread turn at the height of the contact pressure angle. The ball bearings are thereby gradually exposed to or withdrawn from the rolling friction due to the relative movement of the threaded spindle and the nut and are automatically carried into or out of a ball bearing return channel on the nut. In contrast to the state of the art, the ball bearings are thereby not abruptly advanced and pressed jerkily into the thread turns, which are jointly formed by the ball bearing raceways on the nut and the threaded spindle.

It may be expedient to form two or more ball bearing chains in the ball screw mechanism, with two or more thread turns and a ball bearing return comprising a ball bearing return channel and ball bearing reversal members. The ball bearing return with the ball bearing reversal members and the ball bearing return channel is preferably accommodated in the circumferential surface of the nut. The ball bearing reversal member is preferably integrally formed by a forming and/or casting process and is made from a metal or non-metallic material. The ball bearing return channel preferably runs at a small radial distance from the circumference of the threaded spindle substantially or entirely inside the nut. The ball bearing return channel, which preferably runs as a basically axial bore in the circumferential surface of the nut, is led at a tangent to the transitional area of the ball bearing reversal member to the ball bearing raceways, so that the respective ball bearing reversal member can be formed as an insert for the nut and the opening in the ball bearing return channel and the ball bearing reversal member can come to lie in alignment with one another once the respective ball bearing reversal member has been inserted into the nut.

In an especially preferred embodiment of the nut which is easy to assembly, the ball bearing reversal members are positioned at axial ends of the nut or in proximity thereto, so that the ball bearing reversal members can easily each be fixed in the nut by an axial securing element, such as a retainer ring, and/or a spring element, such as a steel disc arranged between the retainer ring and the ball bearing reversal member and preferably coated with an elastomer material such as rubber. The ball bearings roll over a gothic raceway profile, at least in the area of the ball bearing reversal members.

The invention will now be described in more detail with reference to an exemplary embodiment and to the attached drawings.

### BRIEF DESCRIPTION OF THE DRAWINGS

FIG. 1 shows a longitudinal section through a ball screw mechanism having an electromechanical drive,

FIG. 2 shows a partial longitudinal section and a view of the ball screw mechanism in FIG. 1.

FIG. 3 shows a perspective view of a ball bearing reversal member,

FIG. 4 shows a view of an end face of a nut of the ball screw mechanism in FIG. 1,

FIG. 5 shows a cross section through a gothic raceway profile with oblique chamfering of the ball guide for the nut of the ball screw mechanisms in FIG. 1.

### DETAILED DESCRIPTION OF THE PREFERRED EMBODIMENTS

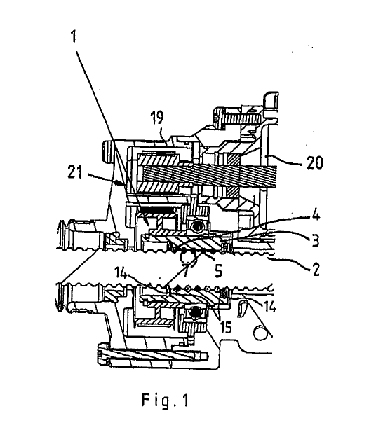

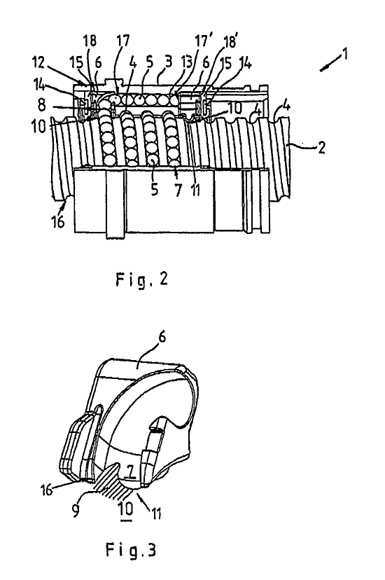

FIG. 1 shows a longitudinal section through a ball screw mechanism 1 for an electromechanical power-assisted steering system of a motor vehicle. A threaded spindle 2, rotatably held in a transmission casing 19, is connected to a manual steering control of the motor vehicle by way of a rack (not shown), on which a pinion, rotational locked to the manual steering control, meshes. Both the ball screw mechanism 1, the threaded spindle 2 and the electric motor 20, which acts on a nut 3 by way of a reduction gear 21, are arranged in the transmission casing 19. Around its circumference the threaded spindle 2 has helical ball bearing raceways 4 of approximately the same pitch as helical ball bearing raceways 4 in the nut 3. The nut 3 has the threaded spindle 2 passing through it and is operatively connected to the threaded spindle 2 by ball bearings 5 of a ball bearing chain 7, which are enclosed in the ball bearing raceways 4 of the threaded spindle 2 and the nut 3, and in a ball bearing return 12, in each case comprising a ball bearing reversal member 6 (cf. FIG. 2) and a ball bearing return channel 13. The threaded spindle 2 is displaced as the nut 3 rotates axially thereon. Connected to the threaded spindle 2 is a connecting mechanism, comprising track rods and steering arms to the steered wheels of the motor vehicle, so that under an axial displacement of the threaded spindle 2 on the nut 3 a wheel angle of the steered wheels is adjusted. The ball bearings 5 run with smallest possible play in the ball bearing raceways 4.

In order to allow a smooth introduction of the ball bearings 5 into the ball bearing raceways 4 and a smooth removal therefrom, and to ensure a continuous, uniform radial support for the threaded spindle 2 on the nut 3, one or more ball bearing chains 7 are provided, which form a closed thread turn of more than 360°, without interruption of the load-bearing ball bearing raceway. At the axial ends 17, 17′ of a ball bearing return channel 13, ball bearing reversal members 6 are moreover inserted and fixed into the wall of the nut 3, said members being designed so that in their transitional area 8 to the ball bearing raceways 4 they have a base area, which continuously diminishes towards the ball bearing raceways 4 and which in turn permits a continuously progressive variation in the contact area 9 of the ball bearings 5 with the ball bearing raceways 4. This allows the ball bearings 5, due to the rolling friction in a relative movement of the threaded spindle 2 and the nut 3 in a load entry/load exit zone 10 to run smoothly at these widening ends 11 of the nut 3 and its ball bearing reversal members 6 (cf. FIGS. 2, 3).

FIG. 2, in a partially longitudinal section and in a view of the ball screw mechanism 1 in FIG. 1, shows the construction of the ball screw mechanism 1 having a single ball bearing chain 7, which extends over approximately four thread turns of the nut 3. The same reference numbers as in FIG. 1 apply to identical parts.

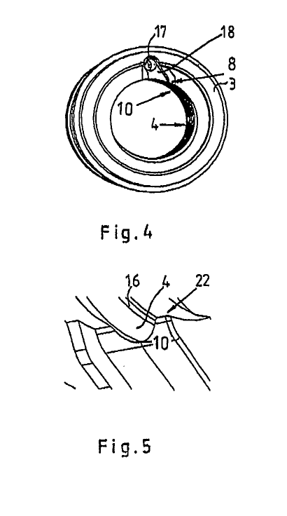

As FIGS. 2 and 4 show, the ball bearing return channel 13 is led approximately axially in the circumferential surface of the nut 3, so that its opening is arranged at a tangent to the respective end 11 of the ball bearing reversal members 6. The ball bearing reversal members 6 therefore serve both to reverse the ball bearings 5 from the ball bearing return channel 13, and also to introduce and remove the ball bearings 5 from the ball bearing raceways 4.

As shown in FIG. 3, the ball bearing reversal members 6 are integrally cast. As FIGS. 2 and 4 illustrate, at the ends of the nut 3 they can be inserted in an axial direction into openings 18, 18′ precisely true to size, and each fixed in the nut 3 by an axial securing element 14, such as a retainer ring and preferably with a spring element 15, such as a steel disc coated with an elastomer material, such as rubber.

FIG. 5 shows a view of a load entry and load exit zone 10 on the nut 3 in the area of a contact pressure angle 22 with a gothic raceway profile 16, which is endowed with a fork structure in that the raceway profile 16 is obliquely chamfered and a linear guide for the ball bearings 5 is forked in this area, so that the ball bearings 5 are automatically entrained due to the rolling friction occurring in a relative movement between the threaded spindle 2 and the nut 3. This ensures a quiet, smooth operation of the ball screw mechanism 1.

1. A ball screw mechanism for an electro mechanical steering system of a vehicle comprising a threaded spindle which passes through a nut, the threaded spindle and the nut being provided with ball bearing raceways for jointly receiving load-transmitting ball bearings inside the nut, and the nut having ball bearing reversal members for removing and introducing the ball bearings into the ball bearing raceways, the ball bearings being arranged in a closed chain over approximately two or more thread turns in the ball bearing raceways, the nut with the ball bearing reversal members in their transitional area to the ball bearing raceways being designed so as to ensure an almost continuously progressive change in the contact area between the ball bearing raceways of the threaded spindle and the ball bearings for the defined entry or exit of the ball bearings at a load entry and load exit zone in the transitional area.

2. (canceled)

3. The ball screw mechanism as claimed in claim 1 wherein the ball bearing reversal members, in their transitional area diminish almost continuously in their base area, have diverging ends.

4. The ball screw mechanism as claimed in claim 1, wherein the ball bearings in the transitional area are moved into or out of the load entry or load exit zone due to the rolling friction occurring in a relative movement of the threaded spindle and the nut.

5. The ball screw mechanism as claimed in claim 1, wherein the ball screw mechanism has two or more ball bearing chains with more than one closed thread turn and a ball bearing return comprising a ball bearing return channel and ball bearing reversal members.

6. The ball screw mechanism as claimed in claim 1, wherein the ball bearing return is arranged in the nut.

7. The ball screw mechanism as claimed in claim 1, wherein the ball bearing reversal member is integrally formed.

8. The ball screw mechanism as claimed in claim 1, wherein the ball bearing reversal member is formed by a forming or casting process.

9. The ball screw mechanism as claimed in claim 1, wherein the ball bearing reversal member is formed from a metal or a non-metallic material.

10. The ball screw mechanism as claimed in claim 5, wherein the ball bearing return channel runs substantially in an axial direction in the nut.

11. The ball screw mechanism as claimed in claim 5, wherein the ball bearing return channel is lead substantially at a tangent to the transitional area of the ball bearing reversal member to the ball bearing raceways.

12. The ball screw mechanism as claimed in claim 1, wherein the ball bearing reversal members are fixed in the nut by an axial securing element and/or a spring element.

13. The ball screw mechanism as claimed in claim 1, wherein a gothic raceway profile of the nut is formed in the transitional area by an oblique chamfer.

14. A nut for a ball screw mechanism of a steering system, wherein the nut, has a load entry and load exit with a fork structure providing for smooth entry or exit of the ball bearings of the ball screw mechanism, and the ball bearings from a ball bearing return are guided along edges of a gothic raceway profile of the nut, until they enter the ball bearing raceway at the height of a contact pressure angle.
